(19) United States
(12) Patent Application Publication
(10) Pub. No.: US 2016/0117087 A1
(43) Pub. Date: Apr. 28, 2016

(54) JOB CREATION AND REUSE

(71) Applicant: Microsoft Corporation, Redmond, WA (US)

(72) Inventors: Cheryl Couris, Seattle, WA (US); Christina Storm, Seattle, WA (US); Andrew J. Peacock, Seattle, WA (US); Amir Netz, Bellevue, WA (US); Chiu Ying Cheung, Redmond, WA (US); Michael J. Flasko, Kirkland, WA (US); Kevin Grealish, Seattle, WA (US); Giovanni M. Della-Libera, Redmond, WA (US); Sonia P. Carlson, Redmond, WA (US); Mark W. Heninger, Preston, WA (US); Paula M. Bach, Redmond, WA (US); Taurean A. Jones, Issaquah, WA (US); David J. Nettleton, Seattle, WA (US)

(21) Appl. No.: 14/521,468

(22) Filed: Oct. 23, 2014

(51) Int. Cl. G06F 3/0484; G06F 3/0482

(52) U.S. Cl. CPC G06F 3/04847; G06F 3/0482; G06F 3/04842

(57) ABSTRACT

Jobs can be created within a visual authoring environment. A new job of a selected type can be added to a diagrammatic workspace. Subsequently, a mechanism configured to enable selection of a saved job that implements all or a portion of the job can be presented. After selection, a saved job can be acquired and the workspace updated based thereon. Furthermore, data sources associated with the saved job can be can be added to a data source designated portion of the environment.

### BACKGROUND

Processing of vast quantities of data, or so-called big data, to glean valuable insight involves first transforming data. Data is transformed into a useable form for publication or consumption by business intelligence endpoints, such as a dashboard, by creating, scheduling, and executing of one or more jobs. In this context, a job is a unit of work over a data comprising one or more transformation operations. Typically, jobs are manually coded by data developers, data architects, business intelligence architects, or the like.

### SUMMARY

The following presents a simplified summary in order to provide a basic understanding of some aspects of the disclosed subject matter. This summary is not an extensive overview. It is not intended to identify key/critical elements or to delineate the scope of the claimed subject matter. Its sole purpose is to present some concepts in a simplified form as a prelude to the more detailed description that is presented later.

Briefly described, the subject disclosure pertains to job creation and reuse. Jobs can be created based on saved jobs, or portions thereof, within a visual authoring environment. In particular, a new job of a selected type can be added to a diagrammatic workspace. Subsequently, presentation of a mechanism configured to enable selection of a saved job can be triggered. Upon selection, a visual representation of the selected saved job can be added to the workspace including a representation of a job comprising one or more transformation operations and optionally one or more input data sources and an output data source. Furthermore, data sources associated with a saved job can be can be added to a data source designated portion of the environment for subsequent use.

To the accomplishment of the foregoing and related ends, certain illustrative aspects of the claimed subject matter are described herein in connection with the following description and the annexed drawings. These aspects are indicative of various ways in which the subject matter may be practiced, all of which are intended to be within the scope of the claimed subject matter. Other advantages and novel features may become apparent from the following detailed description when considered in conjunction with the drawings.

### BRIEF DESCRIPTION OF THE DRAWINGS

FIG. 1 is a block diagram of a visual authoring system.

FIG. 2 is a block diagram of a representative authoring component.

FIG. 3 is a block diagram of a representative saved component.

FIG. 4 is an exemplary screenshot of a visual authoring interface.

FIG. 5 is an exemplary screenshot of a visual authoring interface associated with adding a new job.

FIG. 6 is an exemplary screenshot of a visual authoring interface associated with adding a new job.

FIG. 7 is an exemplary screenshot of a visual authoring interface associated with implementing a new job.

FIG. 8 is an exemplary screenshot of a visual authoring interface associated with authoring a new job.

FIG. 9 is an exemplary screenshot of a visual authoring interface associated with adding a new job.

FIG. 10 is an exemplary screenshot of a visual authoring interface associated with selecting and implementation from amongst saved jobs.

FIG. 11 is an exemplary screenshot of a visual authoring interface including a visualization of a saved job.

FIG. 12 is a flow chart diagram of a method of facilitating job authoring.

FIG. 13 is a flow chart diagram of a method of updating a visual authoring environment with a saved job.

FIG. 14 is a flow chart diagram of a method of interacting with a saved job in a visual authoring environment.

FIG. 15 is a flow chart diagram of a method of creating a job.

FIG. 16 is a schematic block diagram illustrating a suitable operating environment for aspects of the subject disclosure.

### DETAILED DESCRIPTION

Details below generally pertain to job creation and reuse. Rather than authoring a job from scratch, a job can be created based on saved job within a visual authoring environment. A new job can be added to diagrammatic workspace in response to a user request. The new job can be devoid of an implementation, or more specifically, the new job lacks transformation operations. Further, the new job can be of a particular type of job. In one instance, a plurality of job types can be presented for selection in conjunction with creating a new job. In accordance with one aspect, upon selection of the new job, a previously created and saved job can be identified, loaded, and subsequently laid out as a diagram in the workspace. For instance, a dialog box can be presented that enables a user to locate and select a saved job. Upon selection, the visual representation of the new job can be replaced with a visualization of the saved job including one or more transformation operations, and optionally one or more input and result data sources. Visual representations of the one or more input data sources of the saved job can also be presented in a data source area to enable selection and utilization with respect to authoring other jobs.

In accordance with one embodiment, a saved job can correspond to a template or the like, wherein solely a portion of a job is implemented. Such a job can be configured utilizing a code editor to specify additional code manually that completes the job. Additionally or alternatively, the additional code can be generated automatically based on interaction with visualizations representing transformation operations. Furthermore, even if the entire job is implemented the same techniques can be used to alter the job, if desired.

Of course, job creation is not limited to using previously saved jobs. In particular, a new job can be authored manually with a code editor, automatically based on interactions with visualizations representing transformation operations, or a combination of manually and automatically. Further, the jobs can be created outside the disclosed visual authoring environment. In one instance, these jobs or portions thereof can subsequently be saved for later use by the creator or others in an organization, for example. In other words, a toolbox of user created and saved jobs can be built to facilitate later job authoring by way of reuse.

Various aspects of the subject disclosure are now described in more detail with reference to the annexed drawings, wherein like numerals generally refer to like or corresponding elements throughout. It should be understood, however, that the drawings and detailed description relating thereto are not intended to limit the claimed subject matter to the particular form disclosed. Rather, the intention is to cover all modifications, equivalents, and alternatives falling within the spirit and scope of the claimed subject matter.

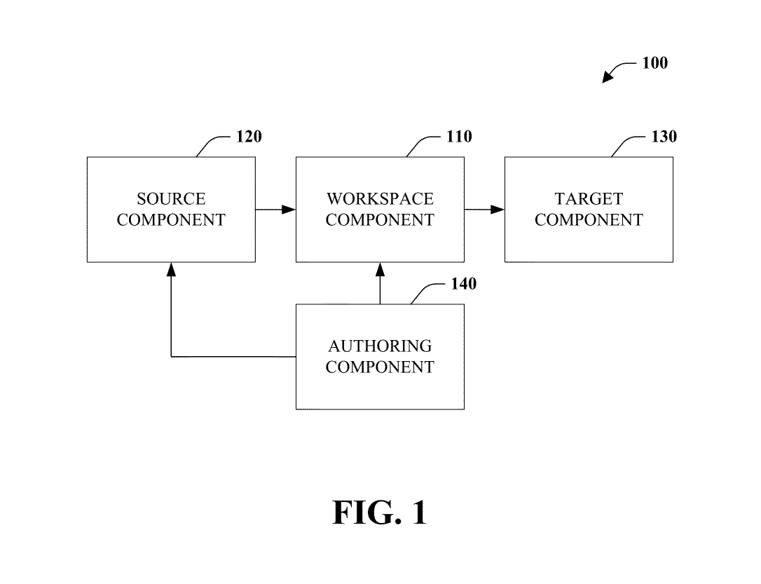

Referring initially to FIG. 1, a visual authoring system 100 is illustrated. The visual authoring system 100 includes workspace component 110, source component 120, target component 130, and authoring component 140 configured to afford a visual authoring environment. The workspace component 110 is configured to enable diagrammatic authoring of jobs and data transformation pipelines, by providing an interactive visual workspace or canvas. For example, data sources can be represented as cylinders and connected by arrows to jobs that produce modified data sources. Essentially, a user can draw a diagram of relationships between data sources and jobs. This results in a very intuitive experience that saves time with respect to understanding relationships and ultimately authoring jobs.

The source component 120 is configured to produce a visual representation of data sources available for use in job creation. Arbitrary data sources can be acquired and made available by the source component 120 including on-premises data sources and cloud-based data sources of substantially any format (e.g., table, stream, file . . . ) and structure (e.g., structured, unstructured, semi-structured). In other words, the data sources are heterogeneous. The source component 120 can visualize data sources or datasets available to an individual or organization. Data sources can made available by search and import functionality provided by the source component 120. Additionally, the source component 120 can be configured to monitor user or entity accounts or the like and make accessible data sources available automatically. Data sources rendered by the source component 120 are interactive and can be used as input for one or more jobs. For example with a gesture, such as drag-and-drop, a data source from a source area can be added to a workspace.

The target component 130 is configured to provide a visual location to display final data sources after all transformations have been applied. These data sources can subsequently be published or consumed by an application, such as an analytics application. A result of a job, or series of jobs, can be dragged from the workspace and dropped in a target visualization area, for example.

The authoring component 140 is configured to enable visual authoring of jobs comprising one or more transformation operations and pipelines comprising a one or more input datasets, a job, and an output dataset. In particular, the authoring component 140 can interact with at least the source component 120 and the workspace component 110 to facilitate job construction in conjunction with a diagram in a workspace from available data sources.

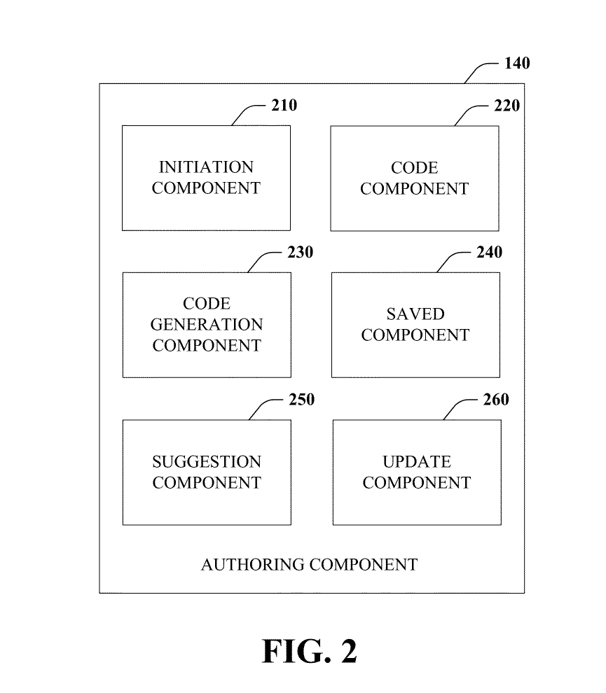

Turning attention to FIG. 2 a representative authoring component 140 is depicted. The authoring component 140 comprises a number of subcomponents including initiation component 210, code component 220, code generation component 230, saved component 240, suggestion component 250, and update component 260.

The initiation component 210 is configured to facilitate initiation of job authoring. In particular, the initiation component 210 can provide visual and interactive mechanisms to aid a user in generating a new job. For example, a new job operation can be visually presented in a toolbar. Upon selection or otherwise activating the new job operation, a list of a plurality of different job types can be presented. A job types can provide particular types of operations (e.g., map-reduce, machine learning, query, extract-transform-load . . . ) over specific types of data sources (e.g., tables, streams, unstructured . . . ). Examples of job types are Hive, Pig, SQL Server Integration Services (SSIS), machine learning, query, and custom. Further, a job type can correspond to a specific programming language (e.g., M-Script). A user can subsequently select one of the different job types to create. In accordance with one interaction, a user can select a job type from amongst the plurality and add it to the workspace, for example by dragging and dropping the job type onto the workspace. Regardless of gesture, selection of a job type can result in generation of a new job and visual representation thereof (e.g., node) on the workspace. The new job can be a shell job devoid of transformation operations. However, the new job need not be an empty container, but rather can include standard or boilerplate code, for example associated with all jobs or a particular job type.

The code component 220 is configured to provide a mechanism to code transformation operations manually. In particular, the code component 220 can present a code editor that allows a user to specify transformation operations in a particular programming language, such as a scripting language. When finished, a user can commit the operations resulting in transformation of a new job or shell job to a particular job with one or more transformation operations. Further, the code component 220 can present a code editor in context or, in other words, in situ, with at least a visual workspace, such that user need not move to a different context or window to specify code. For example, the code editor can be presented alongside the workspace.

The code generation component 230 is configured to generate code capturing transformation operations automatically. In accordance with one aspect, data transformation operations of a programming language can be exposed to graphically. In this manner, users can author a job by selecting one or more visual representations of data transformation operations. Upon selection, code that implements the operations can be generated automatically. In accordance with one embodiment, the visual representations of operations can be presented in conjunction with a data preview that displays at least a subset of data associated with a source. Further, upon selecting a data operation the subset of data can be updated to reflect application of the operation. This enables quick sandboxing and experimenting by way of a test environment. Once a user is satisfied with the specified transformation operations, the code generation component 230 can automatically generate the corresponding code or program. Of course, code can be generated after or upon selection of an operation rather than waiting until all operations are specified.

The saved component 240 enables saved jobs to be integrated within the visual authoring environment. A saved job refers to a job or portion of a job that was previously created and saved for subsequent use and reuse. For example, a saved job can correspond to a favorite job or template job. In one instance, a library of saved jobs can be built to enable reuse. For example, an individual user can create and save jobs or job templates for later reuse in a library or toolbox. As another example, jobs or job templates can be saved across an organization with organization users authoring and contributing jobs to an accessible library. Moreover, the saved component 240 is configured to interact with the workspace component 110 to present a saved job thereon. This enables users to quickly and visually see the flow of data through a pipeline of transformations being created. The visualization can also enable users to quickly understand, the input, process, and output associated with a job and allow changes to be made inline, as needed. Further, the saved component 240 is configured to interact with the source component 120 to enable data sources associated with saved jobs to be presented and made available through a source visualization.

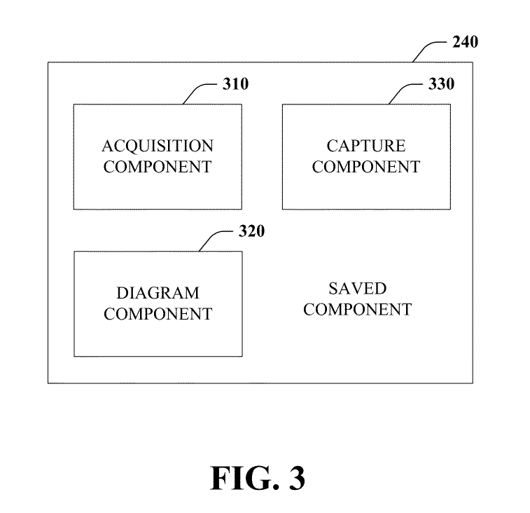

FIG. 3 depicts a representative saved component 240 in further detail. As shown, the saved component 240 includes acquisition component 310, diagram component 320, and capture component 330.

The acquisition component 310 is configured to enable acquisition of a saved job. A saved job comprises a set of one or more data transformation operations and optionally one or more input data sources and an output data source. In one instance, a saved job can correspond to, and be termed, a saved pipeline, if the saved job also includes one or more input data sources and one or more output data sources. A saved job is one that was partially or fully authored by a user at a prior time and saved for later use and reuse. The acquisition component 310 provides a mechanism to obtain a job from a stored location. In one instance, the acquisition component 310 can be embodied as a dialog box that is presented upon selecting a representation of a new job or shell job, in a workspace. The dialog box can enable a user to search for and locate a saved job stored locally or remotely. Other mechanisms are also contemplated including search and select functionality with respect to a library of saved jobs, for example, among others.

The diagram component 320 is configured to generate a visual diagram of a saved job including optionally one or more input data sources and an output data source. In one instance, saved job was authored outside the disclosed visual authoring environment. For example, a user could have manually coded a SQL Server Integration Services (SSIS) package, which is a particular type of job that performs an extract, transform, and load process, outside the virtual authoring environment. The diagram component 320 can generate a diagram of the package that can be presented in the workspace. Similar operations can be performed to diagram other types of jobs such as a machine learning job, Hive job, Pig job, and M-Script job, among others. In this manner, jobs of different types can be visualized and employed in conjunction with visually authoring a workflow pipeline over arbitrary data sources.

The capture component 330 is configured to facilitate capturing and saving of data jobs. For instance, the capture component 330 can provide a mechanism for selecting one or more jobs in a workspace and saving the jobs for later use. By way of example, the capture component 330 can provide a mechanism that allows selection of a job and optionally one or more input data sources and an output data source and subsequently initiate a save thereof to a saved job library or the like. In accordance with one aspect, a user can select a job to be saved. Additionally, a job can be selected and saved automatically. Among other things, this can facilitate reuse of recent jobs or common jobs.

Returning to FIG. 2, the suggestion component 250 is configured to suggest or recommend input sources for a job. A job can be analyzed by the suggestion component 250 and input sources recommended based on the transformation operations. Current and historical context information can also be used to guide recommendations. For instance, if one or more data sources are already connected to a job, those data sources can be used as a basis for identifying and suggesting additional relevant data sources. In addition, if a saved job was previously employed with a specific data source, that data source and/or others similar thereto can be identified and suggested. Further, other jobs and relationships between jobs in the workspace can be considered with respect to recommending relevant data sources. Further yet, user defined tags, or other metadata, associated with data sources can be employed to determine whether or not a data source is relevant to a job, and if so, recommend the source. Suggestion can be visualized in a number of different ways. For example, in one instance, the suggested data sources can be highlighted in a source area. As another example, recommended data sources can be bubbled up in workspace area. In other words, recommended data source are presented in bubbles or like graphical element in the workspace.

The update component 260 is configured to update a workspace and a source portion of a visual authoring environment based on changes. For example, after a saved job is acquired and a diagram of the saved job is generated, the workspace can be automatically updated to include the diagram. Further, a new job shell can be replaced or updated with the representation of a specific job. Furthermore, a saved job can optionally include specification of one or more input data sources. In this case, the update component 260 can be configured to add the input data source or otherwise visualize the source with respect to a source panel of an interface, for example. In this manner, the input sources become available for further job authoring.

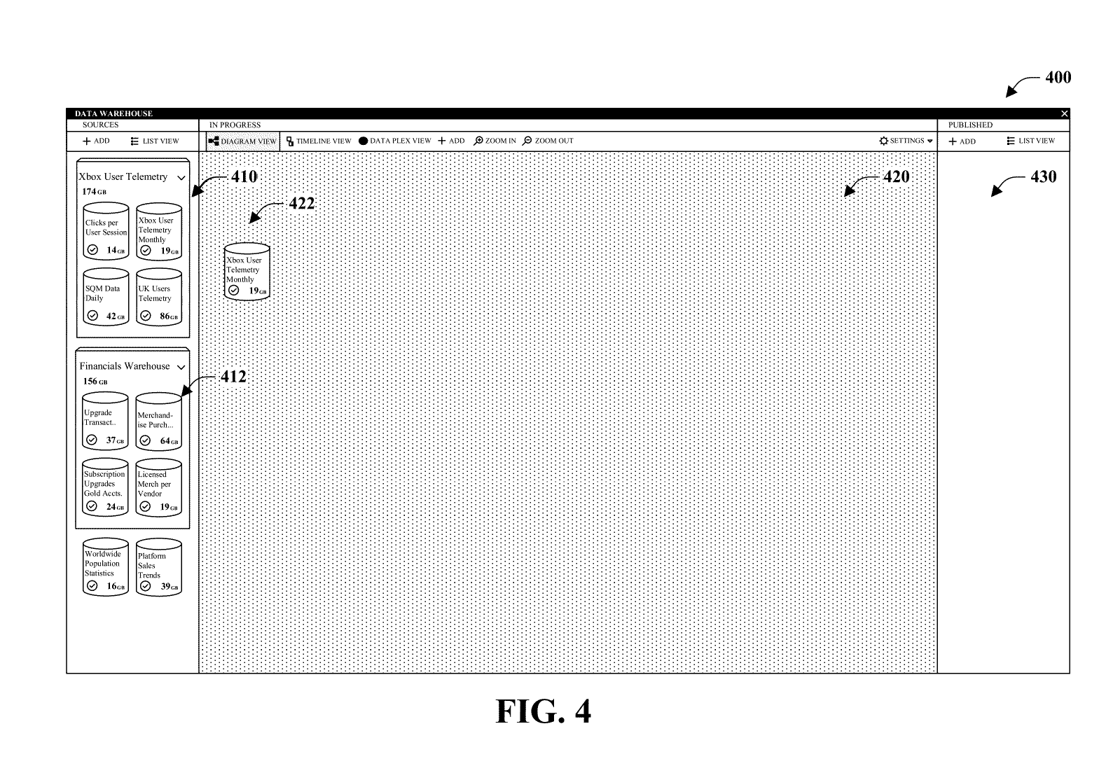

FIGS. 4-11 are exemplary screenshots illustrating various visualization aspects associated with the visual authoring system 100. These screenshots are intended to aid clarity and understanding with respect to aspects of this disclosure and are not intended to limit the claimed subject matter thereto. It is to be appreciated that the provided screenshots depict solely one implementation. Various other combinations and arrangements of graphical elements and text are contemplated and intended to fall within the scope of the appended claims.

FIG. 4 is a screenshot of a visual authoring interface 400 that can be produced by the visual authoring system 100. As shown, the interface 400 includes three panels, namely source panel 410, workspace panel 420, and published panel 430. The source panel 410 presents a plurality of available data sources 412 and enables sources to be added or deleted therefrom. It should be appreciated that the data sources 412 depicted in source panel 410 can be arbitrary data sources. For example, some data sources 412 can be associated with on-premises data while other data sources are associated with network or cloud data stores. Further, the data sources 412 can be of substantially any structure or format. Further yet, the data sources are displayed in groups to facilitate location of relevant sources. The workspace panel 420 provides an interactive diagrammatic view of data sources and jobs. As shown, a data source represented as a first cylinder 422 can be dragged and dropped from the source panel 410 to the workspace panel 420. The published panel 430 provides visual representation of published or consumable data sources after all desired transformations are performed.

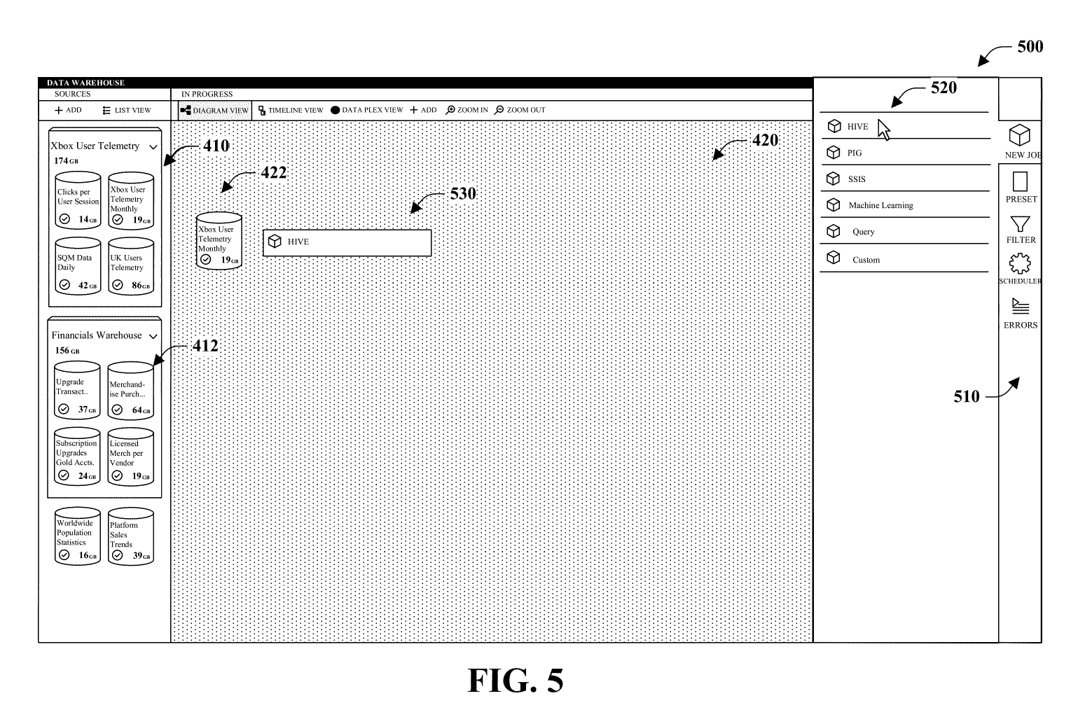

FIG. 5 is a screen shot of a visual authoring interface 500 produced by the visual authoring system 100 associated with addition of a new job. Similar to visual authoring interface 400, the subject interface includes the source panel 410 including representation of a plurality of data sources 412 as well the workspace panel 420 comprising a data source represented as a first cylinder 422. Additionally, toolbar 510 is presented on the right side of the interface including number of operations. Activated is the new job operation, which presents menu 520. The menu displays a plurality of different job types. For example, job types include Hive, Pig, SQL Server Integration Services (SSIS), machine learning, query, and custom. Hive and Pig job types support map-reduce transformations over unstructured and semi-structured data in different ways. SSIS type jobs are extract, transform, and loading (ETL) operations associated with a particular data warehousing technology. Machine learning type jobs involve operations associated with machine learning technology including training and employing models, among other things. Query type jobs specify operations associated with retrieving data based on specific criteria. As shown, a user selects a Hive type job from the menu 520 and drags a representation of the Hive type job in the workplace panel 420.

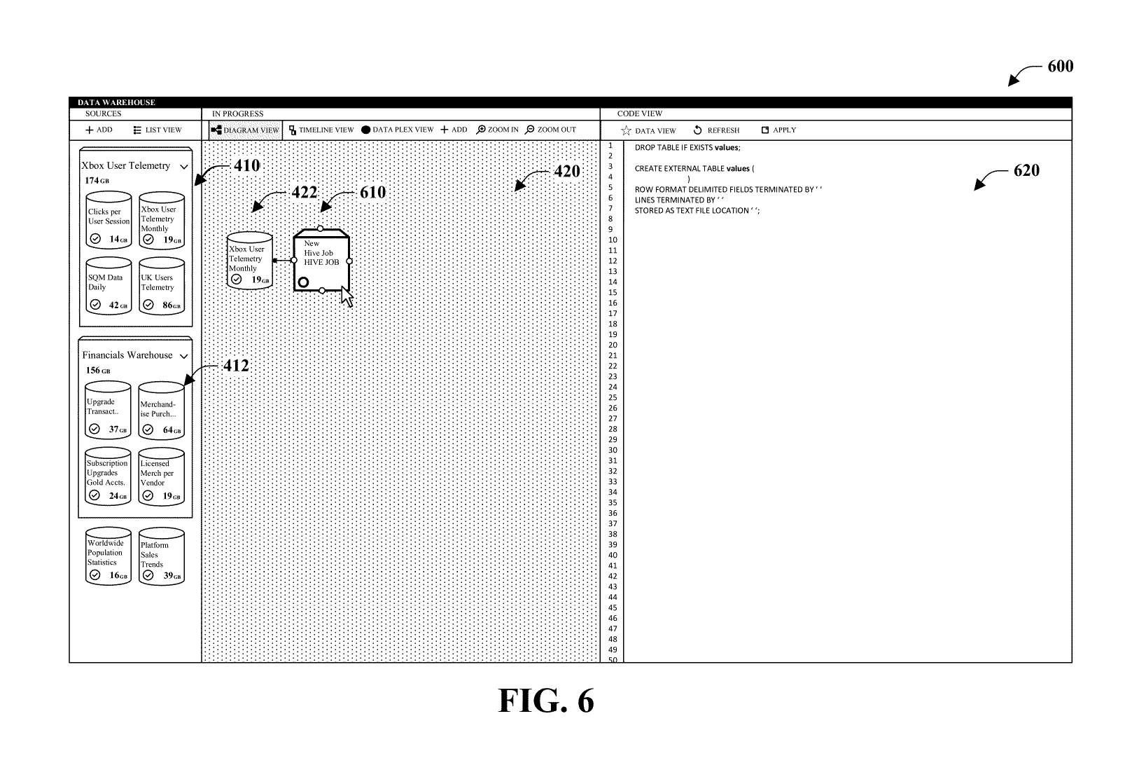

FIG. 6 is a screenshot of a visual authoring interface 600 that can be generated by the visual authoring system 100 associated with adding a new job to a workspace. Similar to previously described interfaces, visual authoring interface 600 includes a source panel including a plurality of representations of data sources 412 and a workspace panel 420 including a first cylinder 422 representing a data source. When a user drops or otherwise adds a job type into the workspace panel, a representation of a new job of that particular type is displayed. Here, a new Hive job is created represented as a first cube 610, which is connected by line and arrow to the first cylinder 422 representing flow from a data source to the job. The new job is devoid of any operations. Thus, a new job is a shell job that acts as a visual placeholder for subsequently defined or configured job. Upon addition of the new job of a particular type to the workspace panel, or some gesture such as clicking on the new job, code view panel 620 is presented. The code view panel 620 is configured to function as a code editor to accept and facilitate specification of code to configure or define the new job. As noted, a new job is devoid of transformation operations but can include boilerplate code associated with all jobs or a particular job type, for example.

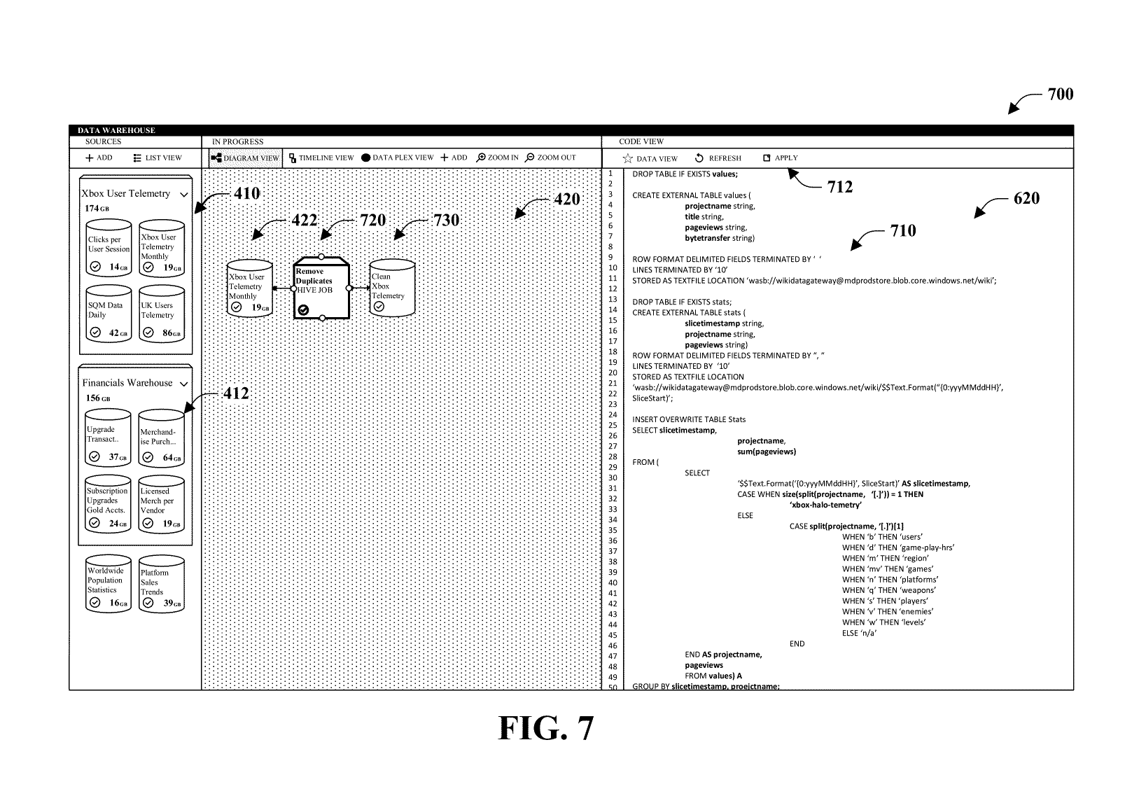

FIG. 7 is a screenshot of a visual authoring interface 700 that can be generated by the visual authoring system 100 associated with defining or configuring a new job. Similar to the visual authoring interface 600, the visual authoring interface 700 includes source panel 410 including data sources 412, workspace panel 420 comprising the first cylinder 422 representing a data source, and the code view panel 620. One or more transformation operations are coded with a programming language. Here, the code 710 defines a remove duplicate operation that removes duplicates from a data set. Upon applying or committing the encoded operations, the workspace panel is updated to replace a representation of a new job with a representation of an implementation of the new job. Second cube 720 replaces or updates a first cube representing a new job of a particular type with a specific job upon application of the code 710 by selecting a visual representation of an apply operation 712. Further, upon apply or a separate instruction to run, output of the job can be produced and represented by second cylinder 730. The second cylinder can be connected with a line and arrow from the second cube 720, to the second cylinder 730 representing direction of data flow.

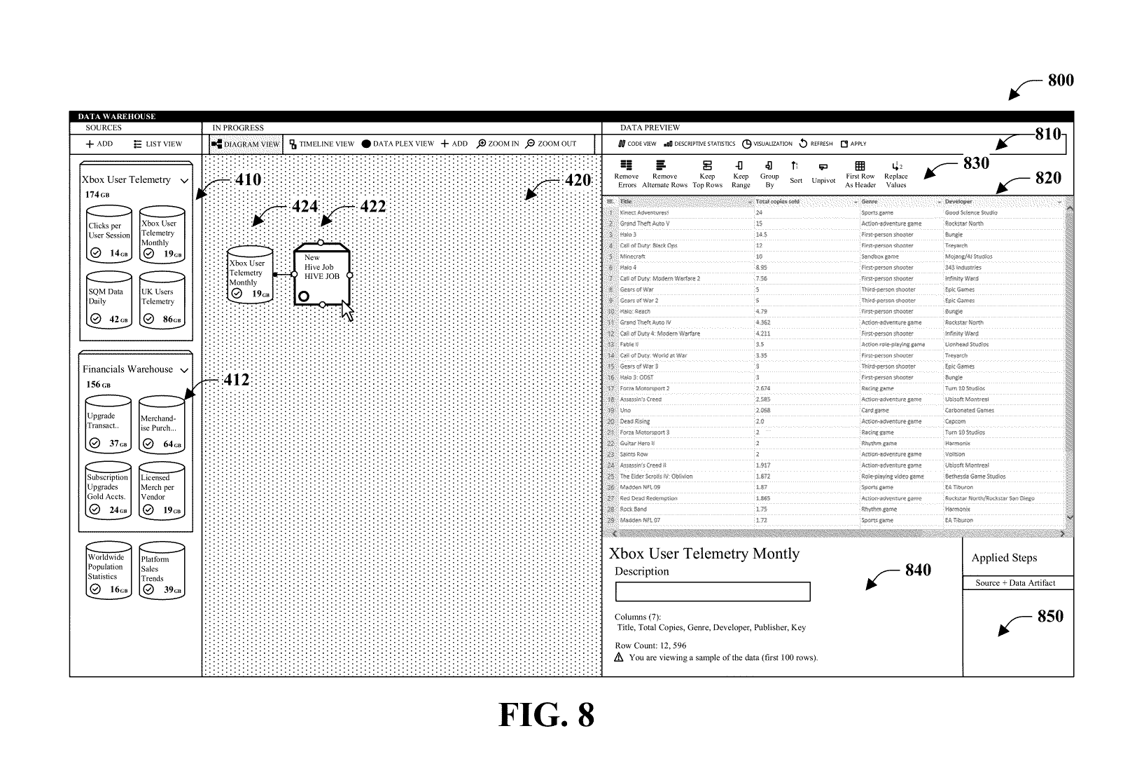

FIG. 8 is a screenshot of a visual authoring interface 800 that can be produced by the visual authoring system 100 associated with defining or configuring a new job. Visual authoring interface 800 is similar to visual authoring interface 600 in that it includes the source panel 410 and the workspace panel 420, as previously described. Rather than or in addition to manually coding operations, a user is presented with a data preview and selectable operations from which the code can be automatically generated. Here, selection of a data source or new job representation can result in presentation of preview panel 810 alongside the workspace panel 420. In a first portion 820 of the preview panel 810, at least a subset of data, here, in a tabular form is presented. The data can be acquired by formulating and issuing a query for a subset of the data and displaying the result. The data provides a user with a general idea of the data included in a data source as well as the effect of changes. Second portion 830 of the preview panel 810 is a toolbar or ribbon including graphical representations of a set of transformation operations. Upon selection, code for the transformation operation can be automatically generated and the first portion 820 can be updated to reflect application of the operation. Third portion 840 of the preview panel 810 displays metadata regarding the source. For example, the name of a data source can be presented as well as the number of rows and columns comprising the data source. Additionally, differences between the data provided in the first portion 820 and the entire data source can be displayed. For example, an indication can be provided noting that the data preview is showing one hundred rows of twelve thousand total or seven of one hundred columns. Furthermore, a user may enter additional metadata such as a description in a text box. Fourth portion 850 of the preview panel 810 presents visual representations of transformation operations that can be applied. Such transformation operations can include removing errors, removing alternate rows, grouping sorting, pivoting, and replacing values, among others.

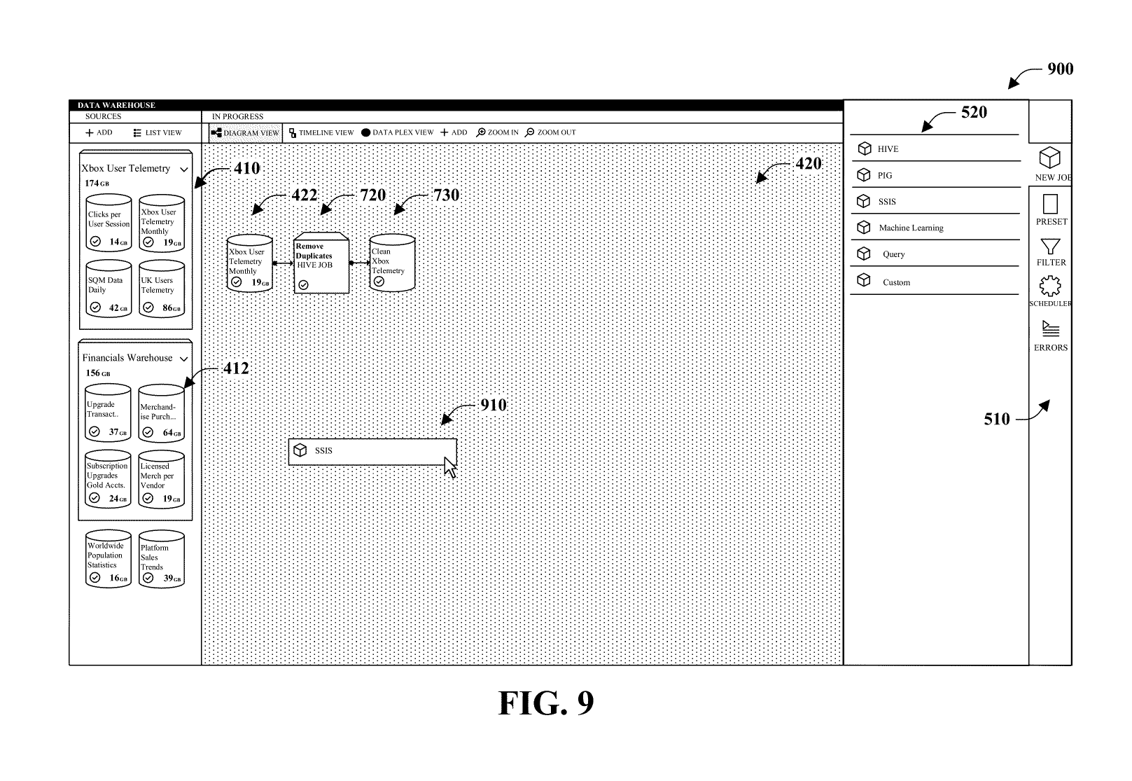

FIG. 9 is a screenshot of a visual authoring interface 900 that can be generated by the visual authoring system 100 associated with authoring a new job. Visual authoring interface 900 is similar to visual authoring interface 700 in that it includes the source panel 410 including data sources 412, and the workspace panel 420 including a first cylinder 422 representing an input data source connected to second cube 720 representing a remove duplicates Hive job and a second cylinder 730 representing the output of the job, as previously described. Additionally the toolbar 510 is presented with the new job operation activated. Upon selection or activation of the new job operation, the menu 520 is presented. The menu specifies job types including Hive, Pig, SSIS, machine learning, query, and custom. A user can select one of the job types to be added to the workspace panel 420. In accordance with one embodiment, a user can select a job type, drag the job type from the menu 520, and drop the job type into the workspace panel 420. Here, a SQL Server Integration Services (SSIS) job type 910 is dragged into the workspace panel 420.

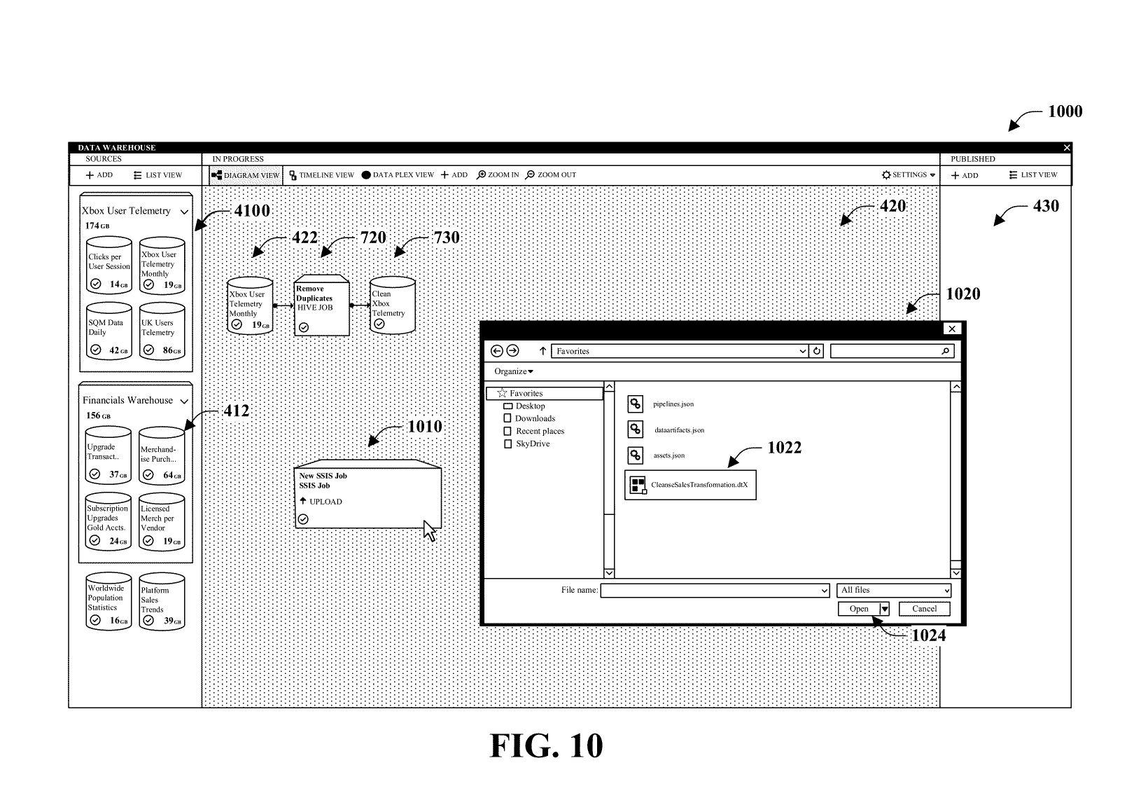

FIG. 10 illustrates a visual authoring interface 1000 that can be produced by the visual authoring system 100. After a job type is dragged and dropped into the workspace panel 420, a representation of the new job 1010 of a particular type is displayed. The new job 1010 is devoid of transformation operations. Accordingly, the new job 1010 can correspond to a stub or shell for transformation operations. Upon selection of the representation of the new job 1010, dialog box 1020 is presented. From the dialog box 1020, a user can search and locate a saved job stored on a local computer or remote networked computer. Here, selection of a saved job is shown at 1022. Subsequently, the open button 1024 can be selected to open the saved job.

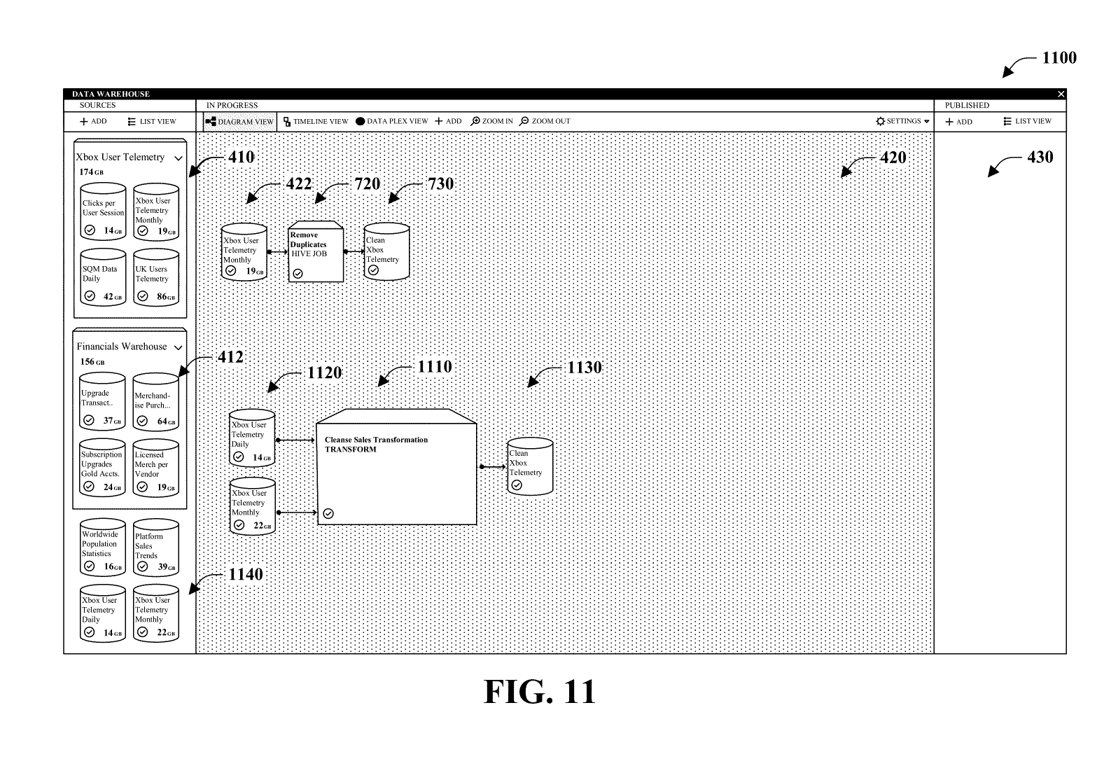

FIG. 11 depicts a visual authoring interface 1100 that can be produced by the visual authoring system 100 in response to opening or loading of a saved job. A visual representation of saved job, here an SSIS package, is presented in the workspace panel 420. In particular, a job 1110 including one or more transformation operations, as well as one or more input data sources 1120, and an output data source 1130 are presented diagrammatically in the workspace panel 420. The input data sources 1120 are connected to the job 1110 by a line with an arrow from the input data sources 1120 to the job 1110 and output data source 1130 is connected by a line with an arrow from the job 1110 to the output data source 1130 indicating data flow from left to right. Further, the source panel 410 is updated automatically to present input data sources 1020 as shown at 1140. Subsequently, the input data sources 1120 are available for use with respect to other jobs.

The aforementioned systems, architectures, environments, and the like have been described with respect to interaction between several components. It should be appreciated that such systems and components can include those components or sub-components specified therein, some of the specified components or sub-components, and/or additional components. Sub-components could also be implemented as components communicatively coupled to other components rather than included within parent components. Further yet, one or more components and/or sub-components may be combined into a single component to provide aggregate functionality. Communication between systems, components and/or sub-components can be accomplished in accordance with either a push and/or pull model. The components may also interact with one or more other components not specifically described herein for the sake of brevity, but known by those of skill in the art.

Furthermore, various portions of the disclosed systems above and methods below can include or employ of artificial intelligence, machine learning, or knowledge or rule-based components, sub-components, processes, means, methodologies, or mechanisms (e.g., support vector machines, neural networks, expert systems, Bayesian belief networks, fuzzy logic, data fusion engines, classifiers . . . ). Such components, inter alia, can automate certain mechanisms or processes performed thereby to make portions of the systems and methods more adaptive as well as efficient and intelligent. By way of example, and not limitation, the suggestion component 250 can employ such mechanisms to determine or infer data sources to suggest relevant to one or more selected operations, or other data sources already linked on an operation, among other things.

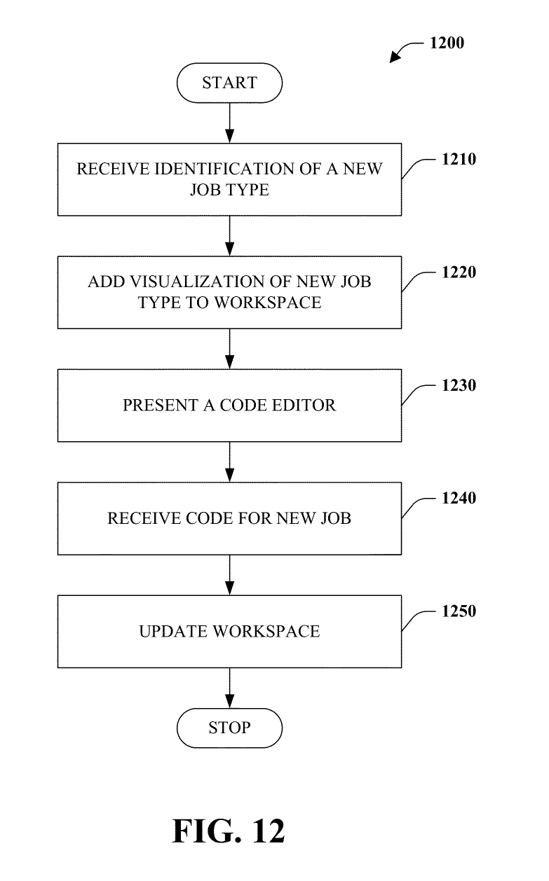

In view of the exemplary systems described above, methodologies that may be implemented in accordance with the disclosed subject matter will be better appreciated with reference to the flow charts of FIGS. 12-15. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described hereinafter.

FIG. 12 is a flow chart diagram of a method 1200 of facilitating job authoring. At reference numeral 1210, identification of a new job type is received. For example, a plurality of job types can be presented in a menu associated authoring a new job, and a user can select one of the job types. At numeral 1220, a visualization of a new job of the identified type is added to a diagrammatic workspace. At reference numeral 1230, a code editor is presented within the context of the workspace. In other words, code editor is presented in a manner that does not require a user to leave the context of the workspace. In this manner, a user can author code that specifies one or more transformation operations to configure or define a job. At numeral 1240, code for a new job is received, for example by way of the code editor. At reference 1250, the workspace is updated to reflect the job defined. For example, a new job visualization object can be replaced or updated to reflect the particular job defined.

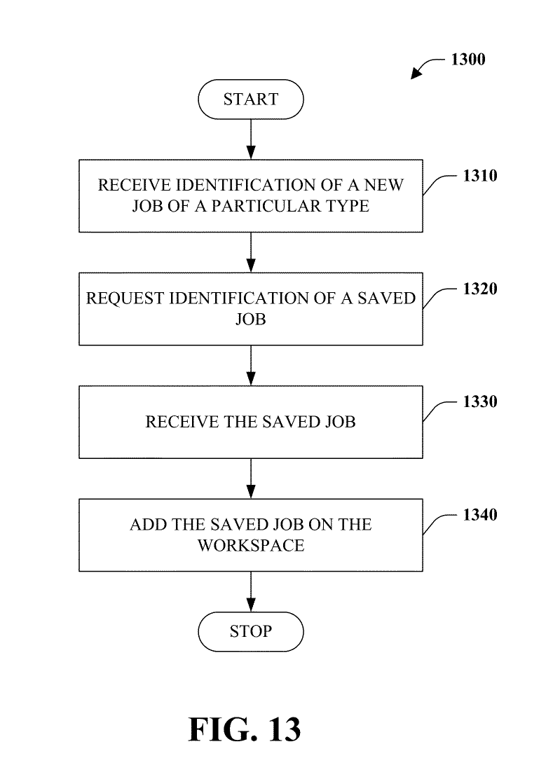

FIG. 13 depicts a method 1300 of facilitating job authoring. At reference numeral 1310, identification of a new job of a particular type is received within a diagrammatic workspace. For example, the new job can be identified by user selection through the workspace. At numeral 1320, identification of a saved job is requested, wherein the saved job correspond a complete or partial job implementation. For instance, a user can identify a saved job corresponding to a template on a local or remote computer. At reference 1330, the saved job is received. The saved job can include one or more transformation operations. At numeral 1340, the saved job is added to a workspace. In this manner, the job is visualized diagrammatically in the workspace. In one instance, a visualization of the saved job can replace or update representation of the new job.

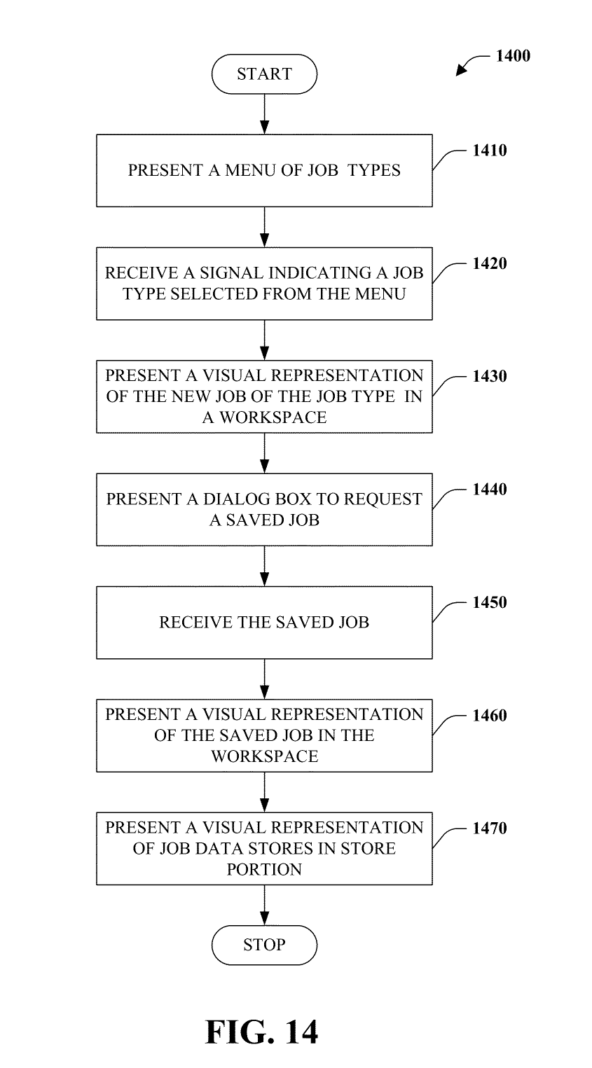

FIG. 14 depicts a method 1400 of visualizing job authoring with a saved job. At reference numeral 1410, a menu is presented in conjunction with a visual authoring environment. In one instance, the menu can be presented upon selection a representation of a new job operation in a toolbar. The menu identifies job types, such as, but not limited to, Hive, Pig, SSIS, machine learning, query, and custom job types. At numeral 1420, a signal is received indicating a selection of job type from the menu. In one instance, a user can select job type and drag-and-drop the job type in a workspace. At reference numeral 1430, a visual of representation of the new job of the identified job type is displayed within the workspace. This new job representation can correspond to a job devoid of any operations or a shell job. At reference 1340, a dialog box is presented that is configured to facilitate request of a saved job comprising a complete (e.g., favorite, recently used . . . ) or partial (e.g., template) job implementation. A user can interact with the dialog box to identify a saved job from a local computer or remote computer. At numeral 1450, the identified saved job is received in response to a request therefor. For example, the saved job can be opened or loaded after selection by way of a dialog box. The saved job can comprise one or more operations, and optionally one or more input data sources and an output data source. The saved job may be have been manually coded or specified with a visual authoring interface and subsequently saved. At reference 1460, a visual representation of the saved job is generated and presented in the workspace. For example, the saved job can be laid out diagrammatically in the workspace, wherein a cube represents one or more operations, cylinders represent data sources, and arrows connect cylinders to cubes to in a manner that indicated dependency as well as data flow. Here, a representation of a new job of a particular type or shell job can be replaced or updated with the selected workflow. At reference numeral 1470, a visual representation of one or more data sources associated with the job are presented in a store portion of the visual authoring environment. For example, visual representations of one or more input data sources can be added to a source portions of a visual authoring environment.

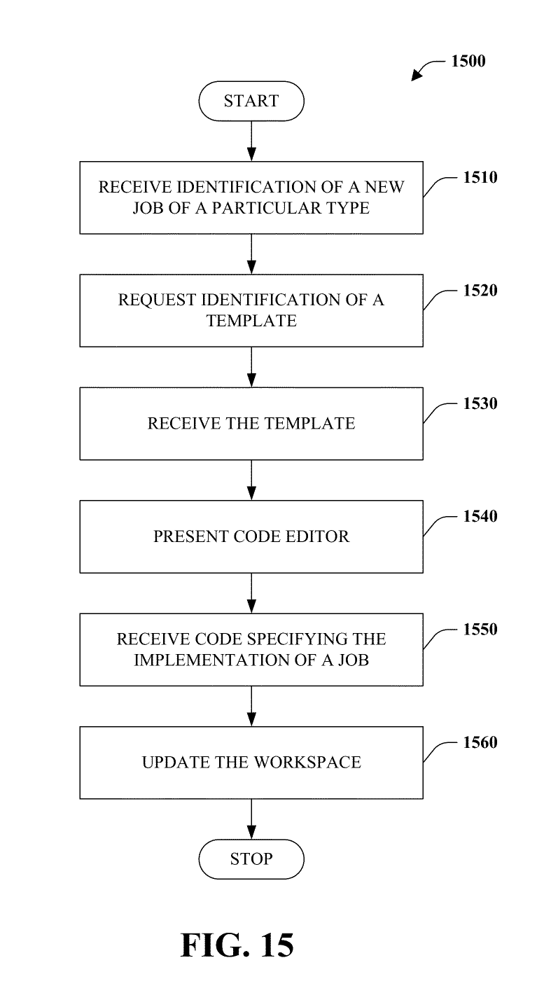

FIG. 15 illustrates a method of creating a job 1500. At reference numeral 1510, identification of a new job of a particular type is received. For example, within a visual authoring environment comprising a diagrammatic workspace, toolbar operation associated with new job can be selected, which reveals a menu of selectable job types. Identification of a template is requested at 1520. Here, a template a saved job that comprises less than complete implementation of a job. For example, a dialog box can be presented within the context of the workspace in allows a user to identify a template. At numeral 1530, the identified template is received from a storage location such as a local computer or network accessible location. At reference numeral 1540, a code editor is presented including code from the template displayed therein. At numeral 1550, a code is received from a user specifying an implementation of a job within the code editor. In other words, a job is specified based on the template. At reference 1560, a workspace is updated to include the job. For instance, a representation of the job, such as a cube, can be presented in the workspace to which at least one input source can be connected and an output source produced.

The subject disclosure supports various products and processes that perform, or are configured to perform, various actions regarding semi-automatic failover. What follows are one or more exemplary methods and systems.

In a computer configured to provide a graphical user interface on a display, a method comprising: presenting on the display a visual representation of an operation configured to add a new job of a select type to a diagrammatic workspace; and presenting on the display a visual representation of the new job, devoid of transformation operations, in the diagrammatic workspace in response to activation of the operation. The method further comprises presenting on the display a dialog box that enables selection of a previously saved job. The method further comprises presenting on the display the dialog box upon selection of the visual representation of the new job. The method further comprises presenting on the display a visual representation of a selected saved job on the workspace. The method further comprises presenting on the display a visual representation of a job comprising one or more data transformation operations, one or more input data sources, and an output data source. The method further comprises presenting on the display a visual representation of one or more input data sources associated with the selected saved job in an area dedicated to available data sources. The method of comprising presenting on the display the visual representation of a selected saved job on the workspace comprises replacing the visual representation of the new job. The method further comprises presenting on the display a menu of job types associated with the new job.

A method comprising: employing at least one processor configured to execute computer-executable instructions stored in a memory to perform the following acts: requesting identification of a saved job; and presenting a visual representation of an identified saved job in a diagrammatic workspace, the visual representation includes a job comprising one or more data transformation operations, zero or more input data sources, and optionally an output data source. The method further comprises presenting a plurality of job types. The method further comprises receiving identification of one of the plurality of job types. The method further comprises presenting a visual representation of a new job of an identified type and devoid of transformation operations in the diagrammatic workspace. The method further comprises presenting a dialog box that enables identification of the saved job upon selection of the visual representation of the new job. The method further comprises replacing the visualization of the new job with the visual representation of an identified saved job on the workspace. The method further comprises presenting a visual representation of one or more input data sources for the identified job in a portion dedicated to data sources.

A system comprising: a processor coupled to a memory, the processor configured to execute the following computer-executable components stored in the memory: a first component configured to initiate acquisition of a saved job in response to addition of a representation of a new job devoid of transformation operations to a diagrammatic workspace; and a second component configured to present a visual representation of the saved job specified in code in the workspace. The system further comprises a third component configured to present a list of job types for selection associated with the new job. The system further comprises a third component configured present a dialog box to enable selection of the saved job. The system further comprising a third component configured to present a visual representation a data source associated with the saved job in a dedicated source area. The system further comprising a third component configured to present suggested data sources based on the saved job.

The word “exemplary” or various forms thereof are used herein to mean serving as an example, instance, or illustration. Any aspect or design described herein as “exemplary” is not necessarily to be construed as preferred or advantageous over other aspects or designs. Furthermore, examples are provided solely for purposes of clarity and understanding and are not meant to limit or restrict the claimed subject matter or relevant portions of this disclosure in any manner It is to be appreciated a myriad of additional or alternate examples of varying scope could have been presented, but have been omitted for purposes of brevity.

As used herein, the terms “component” and “system,” as well as various forms thereof (e.g., components, systems, sub-systems . . . ) are intended to refer to a computer-related entity, either hardware, a combination of hardware and software, software, or software in execution. For example, a component may be, but is not limited to being, a process running on a processor, a processor, an object, an instance, an executable, a thread of execution, a program, and/or a computer. By way of illustration, both an application running on a computer and the computer can be a component. One or more components may reside within a process and/or thread of execution and a component may be localized on one computer and/or distributed between two or more computers.

The conjunction “or” as used in this description and appended claims is intended to mean an inclusive “or” rather than an exclusive “or,” unless otherwise specified or clear from context. In other words, “‘X’ or ‘Y’” is intended to mean any inclusive permutations of “X” and “Y.” For example, if “‘A’ employs ‘X,’” “‘A employs ‘Y,’” or “‘A’ employs both ‘X’ and ‘Y,’” then “‘A’ employs ‘X’ or ‘Y’” is satisfied under any of the foregoing instances.

Furthermore, to the extent that the terms “includes,” “contains,” “has,” “having” or variations in form thereof are used in either the detailed description or the claims, such terms are intended to be inclusive in a manner similar to the term “comprising” as “comprising” is interpreted when employed as a transitional word in a claim.

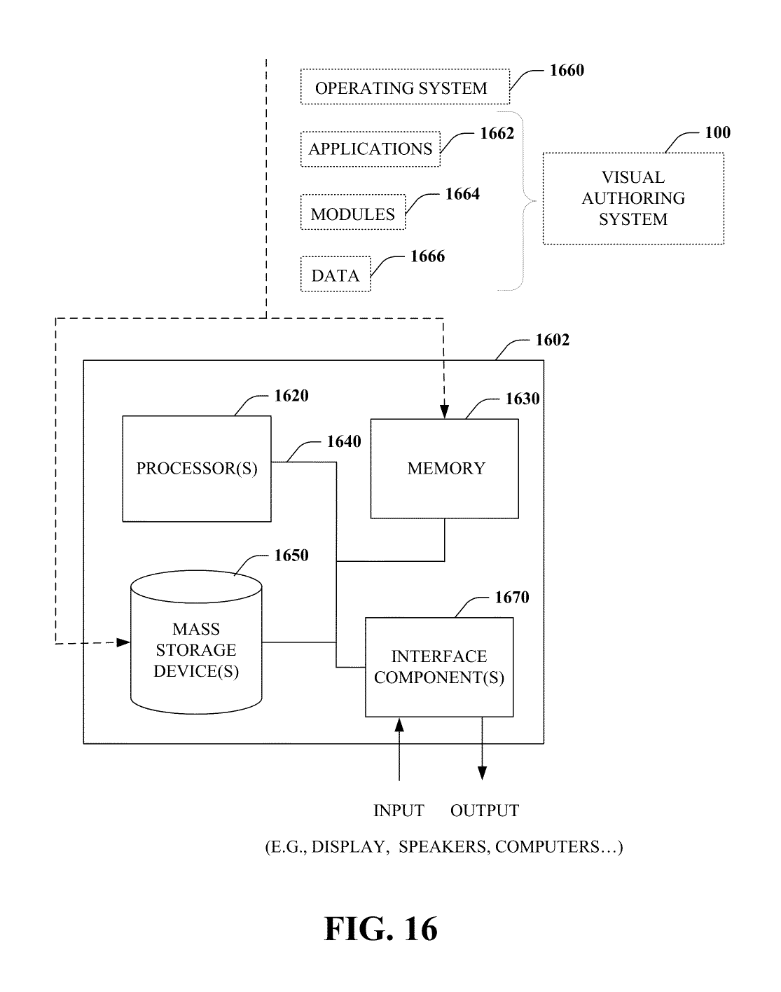

In order to provide a context for the claimed subject matter, FIG. 16 as well as the following discussion are intended to provide a brief, general description of a suitable environment in which various aspects of the subject matter can be implemented. The suitable environment, however, is only an example and is not intended to suggest any limitation as to scope of use or functionality.

While the above disclosed system and methods can be described in the general context of computer-executable instructions of a program that runs on one or more computers, those skilled in the art will recognize that aspects can also be implemented in combination with other program modules or the like. Generally, program modules include routines, programs, components, data structures, among other things that perform particular tasks and/or implement particular abstract data types. Moreover, those skilled in the art will appreciate that the above systems and methods can be practiced with various computer system configurations, including single-processor, multi-processor or multi-core processor computer systems, mini-computing devices, mainframe computers, as well as personal computers, hand-held computing devices (e.g., personal digital assistant (PDA), phone, watch . . . ), microprocessor-based or programmable consumer or industrial electronics, and the like. Aspects can also be practiced in distributed computing environments where tasks are performed by remote processing devices that are linked through a communications network. However, some, if not all aspects of the claimed subject matter can be practiced on stand-alone computers. In a distributed computing environment, program modules may be located in one or both of local and remote memory devices.

With reference to FIG. 16, illustrated is an example general-purpose computer or computing device 1602 (e.g., desktop, laptop, tablet, watch, server, hand-held, programmable consumer or industrial electronics, set-top box, game system, compute node . . . ). The computer 1602 includes one or more processor(s) 1620, memory 1630, system bus 1640, mass storage device(s) 1650, and one or more interface components 1670. The system bus 1640 communicatively couples at least the above system constituents. However, it is to be appreciated that in its simplest form the computer 1602 can include one or more processors 1620 coupled to memory 1630 that execute various computer executable actions, instructions, and or components stored in memory 1630.

The processor(s) 1620 can be implemented with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. The processor(s) 1620 may also be implemented as a combination of computing devices, for example a combination of a DSP and a microprocessor, a plurality of microprocessors, multi-core processors, one or more microprocessors in conjunction with a DSP core, or any other such configuration. In one embodiment, the processor(s) can be a graphics processor.

The computer 1602 can include or otherwise interact with a variety of computer-readable media to facilitate control of the computer 1602 to implement one or more aspects of the claimed subject matter. The computer-readable media can be any available media that can be accessed by the computer 1602 and includes volatile and nonvolatile media, and removable and non-removable media. Computer-readable media can comprise two distinct types, namely computer storage media and communication media.

Computer storage media includes volatile and nonvolatile, removable and non-removable media implemented in any method or technology for storage of information such as computer-readable instructions, data structures, program modules, or other data. Computer storage media includes storage devices such as memory devices (e.g., random access memory (RAM), read-only memory (ROM), electrically erasable programmable read-only memory (EEPROM) . . . ), magnetic storage devices (e.g., hard disk, floppy disk, cassettes, tape . . . ), optical disks (e.g., compact disk (CD), digital versatile disk (DVD) . . . ), and solid state devices (e.g., solid state drive (SSD), flash memory drive (e.g., card, stick, key drive . . . ) . . . ), or any other like mediums that store, as opposed to transmit or communicate, the desired information accessible by the computer 1602. Accordingly, computer storage media excludes modulated data signals.

Communication media embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media.

Memory 1630 and mass storage device(s) 1650 are examples of computer-readable storage media. Depending on the exact configuration and type of computing device, memory 1630 may be volatile (e.g., RAM), non-volatile (e.g., ROM, flash memory . . . ) or some combination of the two. By way of example, the basic input/output system (BIOS), including basic routines to transfer information between elements within the computer 1602, such as during start-up, can be stored in nonvolatile memory, while volatile memory can act as external cache memory to facilitate processing by the processor(s) 1620, among other things.

Mass storage device(s) 1650 includes removable/non-removable, volatile/non-volatile computer storage media for storage of large amounts of data relative to the memory 1630. For example, mass storage device(s) 1650 includes, but is not limited to, one or more devices such as a magnetic or optical disk drive, floppy disk drive, flash memory, solid-state drive, or memory stick.

Memory 1630 and mass storage device(s) 1650 can include, or have stored therein, operating system 1660, one or more applications 1662, one or more program modules 1664, and data 1666. The operating system 1660 acts to control and allocate resources of the computer 1602. Applications 1662 include one or both of system and application software and can exploit management of resources by the operating system 1660 through program modules 1664 and data 1666 stored in memory 1630 and/or mass storage device (s) 1650 to perform one or more actions. Accordingly, applications 1662 can turn a general-purpose computer 1602 into a specialized machine in accordance with the logic provided thereby.

All or portions of the claimed subject matter can be implemented using standard programming and/or engineering techniques to produce software, firmware, hardware, or any combination thereof to control a computer to realize the disclosed functionality. By way of example and not limitation, visual authoring system 100 or portions thereof, can be, or form part, of an application 1662, and include one or more modules 1664 and data 1666 stored in memory and/or mass storage device(s) 1650 whose functionality can be realized when executed by one or more processor(s) 1620.

In accordance with one particular embodiment, the processor(s) 1620 can correspond to a system on a chip (SOC) or like architecture including, or in other words integrating, both hardware and software on a single integrated circuit substrate. Here, the processor(s) 1620 can include one or more processors as well as memory at least similar to processor(s) 1620 and memory 1630, among other things. Conventional processors include a minimal amount of hardware and software and rely extensively on external hardware and software. By contrast, an SOC implementation of processor is more powerful, as it embeds hardware and software therein that enable particular functionality with minimal or no reliance on external hardware and software. For example, the visual authoring system 100 and/or associated functionality can be embedded within hardware in a SOC architecture.

The computer 1602 also includes one or more interface components 1670 that are communicatively coupled to the system bus 1640 and facilitate interaction with the computer 1602. By way of example, the interface component 1670 can be a port (e.g., serial, parallel, PCMCIA, USB, FireWire . . . ) or an interface card (e.g., sound, video . . . ) or the like. In one example implementation, the interface component 1670 can be embodied as a user input/output interface to enable a user to enter commands and information into the computer 1602, for instance by way of one or more gestures or voice input, through one or more input devices (e.g., pointing device such as a mouse, trackball, stylus, touch pad, keyboard, microphone, joystick, game pad, satellite dish, scanner, camera, other computer . . . ). In another example implementation, the interface component 1670 can be embodied as an output peripheral interface to supply output to displays (e.g., LCD, LED, plasma . . . ), speakers, printers, and/or other computers, among other things. Still further yet, the interface component 1670 can be embodied as a network interface to enable communication with other computing devices (not shown), such as over a wired or wireless communications link.

What has been described above includes examples of aspects of the claimed subject matter. It is, of course, not possible to describe every conceivable combination of components or methodologies for purposes of describing the claimed subject matter, but one of ordinary skill in the art may recognize that many further combinations and permutations of the disclosed subject matter are possible. Accordingly, the disclosed subject matter is intended to embrace all such alterations, modifications, and variations that fall within the spirit and scope of the appended claims.

What is claimed is:

1. In a computer configured to provide a graphical user interface on a display, a method comprising:
presenting on the display a visual representation of an operation configured to add a new job of a select type to a diagrammatic workspace; and
presenting on the display a visual representation of the new job, devoid of transformation operations, in the diagrammatic workspace in response to activation of the operation.

2. The method of claim 1 further comprises presenting on the display a dialog box that enables selection of a previously saved job.

3. The method of claim 2 further comprises presenting on the display the dialog box upon selection of the visual representation of the new job.

4. The method of claim 2 further comprises presenting on the display a visual representation of a selected saved job on the workspace.

5. The method of claim 4 further comprises presenting on the display a visual representation of a job comprising one or more data transformation operations, one or more input data sources, and an output data source.

6. The method of claim 4 further comprises presenting on the display a visual representation of one or more input data sources associated with the selected saved job in an area dedicated to available data sources.

7. The method of claim 4, presenting on the display the visual representation of a selected saved job on the workspace comprises replacing the visual representation of the new job.

8. The method of claim 1 further comprises presenting on the display a menu of job types associated with the new job.

9. A method comprising:
employing at least one processor configured to execute computer-executable instructions stored in a memory to perform the following acts:
requesting identification of a saved job; and
presenting a visual representation of an identified saved job in a diagrammatic workspace, the visual representation includes a job comprising one or more data transformation operations, zero or more input data sources, and optionally an output data source.

10. The method of claim 9 further comprises presenting a plurality of job types.

11. The method of claim 10 further comprises receiving identification of one of the plurality of job types.

12. The method of claim 9 further comprises presenting a visual representation of a new job of an identified type and devoid of transformation operations in the diagrammatic workspace.

13. The method of claim 12 further comprises presenting a dialog box that enables identification of the saved job upon selection of the visual representation of the new job.

14. The method of claim 13 further comprises replacing the visualization of the new job with the visual representation of an identified saved job on the workspace.

15. The method of claim 14 further comprises presenting a visual representation of one or more input data sources for the identified job in a portion dedicated to data sources.

16. A system comprising:
a processor coupled to a memory, the processor configured to execute the following computer-executable components stored in the memory:
a first component configured to initiate acquisition of a saved job in response to addition of a representation of a new job devoid of transformation operations to a diagrammatic workspace; and
a second component configured to present a visual representation of the saved job specified in code in the workspace.

17. The system of claim 16 further comprises a third component configured to present a list of job types for selection associated with the new job.

18. The system of claim 16 further comprises a third component configured present a dialog box to enable selection of the saved job.

19. The system of claim 16 further comprising a third component configured to present a visual representation a data source associated with the saved job in a dedicated source area.

20. The system of claim 16 further comprising a third component configured to present suggested data sources based on the saved job.
